(19) United States
(12) Patent Application Publication
(10) Pub. No.: US 2016/0090054 A1
(43) Pub. Date: Mar. 31, 2016

(54) VEHICULAR BATTERY SYSTEM HAVING SWITCH DEVICE

(71) Applicant: DENSO International America, Inc., Southfield, MI (US)

(72) Inventor: Patrick POWELL, Farmington Hills, MI (US)

(21) Appl. No.: 14/863,667

(22) Filed: Sep. 24, 2015

Related U.S. Application Data
(60) Provisional application No. 62/055,221, filed on Sep. 25, 2014.

(51) Int. Cl. B60R 16/03; B60R 16/04

(52) U.S. Cl. CPC B60R 16/03; B60R 16/04

(57) ABSTRACT

A battery system for a vehicle may include a battery pack and a switch device. The battery pack may include a plurality of batteries for providing power to devices in the vehicle. The switch device includes a plurality of switches that are electrically coupled to each of the batteries of the battery pack. The switches are operable to control each of the batteries of the battery pack. For example, two or more batteries of the battery pack may be coupled in series or in parallel, and/or a single battery may be controlled independently from the other batteries.

### CROSS-REFERENCE TO RELATED APPLICATIONS

This application claims the benefit of U.S. Provisional Application No. 62/055,221, filed on Sep. 25, 2014.

### FIELD

The present disclosure relates to a battery system for powering components in a vehicle.

### BACKGROUND

This section provides background information related to the present disclosure which is not necessarily prior art.

Vehicles, such as a hybrid vehicle, an electric vehicle, and/or plug-in hybrid electric vehicle, include an electric motor which generates power to move the vehicle. The electric motor is powered by batteries that may be collectively arranged as a battery pack. In addition to powering the electric motor, the battery pack may also power fans, compressors, an audio system, powered seats, and other electrical components in the vehicle. The battery pack may be part of a battery system that supplies power to low voltage and high voltage devices. More particularly, using DC-DC converters, such as boost and/or buck converters, the voltage outputted by the battery pack can be increased or decreased to supply power to devices having different voltage requirements.

### SUMMARY

This section provides a general summary of the disclosure, and is not a comprehensive disclosure of its full scope or all of its features.

The present disclosure is directed toward a battery system for powering devices disposed in a vehicle. The battery system includes a battery pack and a switch device. The battery pack includes a plurality of batteries. The switch device includes a plurality of switches that are electrically coupled to each of the batteries of the battery pack and are operable to control each of the batteries of the battery pack. As an example, two or more batteries of the battery pack may be coupled in series or in parallel and a connection to a single battery may be controlled independently from the other batteries. In an aspect of the present disclosure, the battery system further includes a battery control module that outputs a command signal to the switch device to control the batteries of the battery pack.

The battery system of the present disclosure may power multiple devices that require different voltage levels by controlling each of the batteries in the battery pack. The switch device may control an individual battery to provide power to a low voltage device (e.g., 12V), may couple two or more batteries in series to provide power to high voltage device (e.g., 48V), and/or may couple one or more batteries to a power source for charging the batteries. Accordingly, the battery system of the present disclosure may not require a boost and/or buck converter for providing power to devices having different voltage requirements.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of a battery system having a switch device of the present disclosure;

FIG. 2 is a functional block diagram of a vehicle system having multiple subsystems;

FIGS. 3A and 3B illustrate an operation of the switch device;

FIGS. 4A, 4B, and 4C are schematics of a portion of a switch device having electrical switches coupled to batteries of a battery pack;

FIG. 5 is a functional block diagram of a battery control module;

FIG. 6 is a functional block diagram of a switch device;

FIG. 7 is an example of a vehicle system for a heavy duty truck, where the vehicle system includes the battery system for powering different devices disposed in the truck;

FIG. 8 is an example of a vehicle-battery operation table for the vehicle system of FIG. 7;

FIG. 9 illustrates the switch device coupled to two battery packs;

FIG. 10 is a functional block diagram of a battery system in a second embodiment that has a switch device for operating a DC motor as an AC motor; and

FIGS. 11 and 12 illustrate an application of the switch device for driving a DC motor with varying voltage.

Corresponding reference numerals indicate corresponding parts throughout the several views of the drawings.

### DETAILED DESCRIPTION

The present disclosure will now be described in detail with reference to the accompanying drawings.

A vehicle may include one or more batteries for powering various devices that require varying levels of electric power. For example, the vehicle may include a motor-generator that requires over 12V, and fans, blowers, and/or a starter that require approximately 12V. To power these devices, the vehicle may include a vehicle battery system of the present disclosure that includes a switch device for controlling each battery of a battery pack in order to provide power to the devices that may have different power requirements.

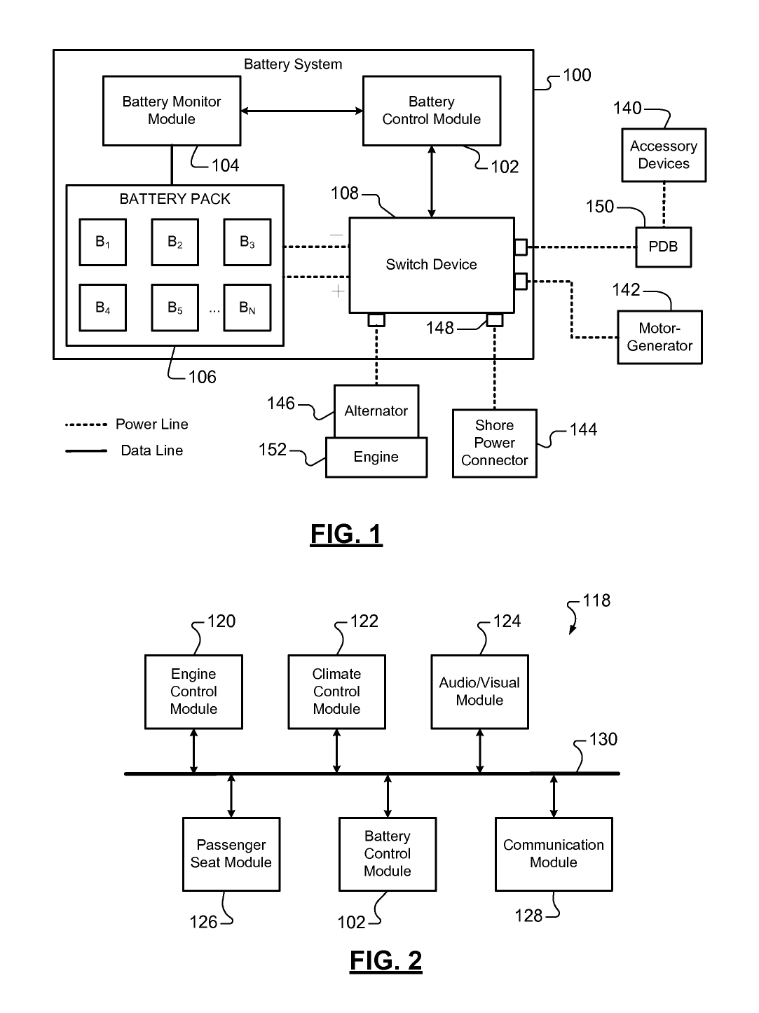

More particularly, with reference to FIG. 1, a battery system 100 controls the supply of electrical power for a vehicle. The vehicle may be, for example, a hybrid vehicle, an electric vehicle, a truck having a diesel-based internal combustion engine, and/or other suitable vehicle having electrical devices requiring varying voltages. The battery system 100 includes a battery control module 102, a battery monitor module 104 (i.e., a battery monitor), a battery pack 106, and a switch device 108. The battery pack 106 includes multiple batteries (B₁, B₂, . . . , B_{N}, where N is an integer), which may be collectively referred to as “batteries B.” The batteries B may have the same voltage or different voltages, such as 12V and/or 24V.

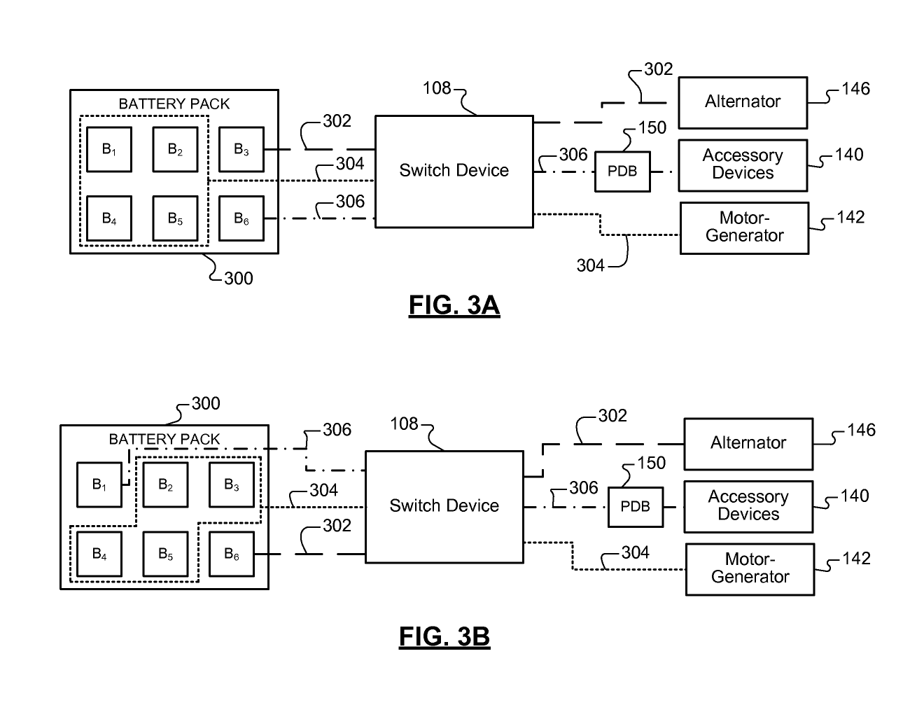

The battery control module 102 communicates with other control modules in the vehicle to assess the power demand of the vehicle. As an example, FIG. 2 illustrates a vehicle control system 118 in which the battery control module 102 is in communication with an engine control module 120, a climate control module 122, an audio-visual module 124, a passenger seat module 126, and a communication module 128, via a data network 130 (e.g., CAN, LIN). The other modules provide information regarding the operation of a system controlled by the respective module. Based on the information received, the battery control module 102 controls the batteries B of the battery pack 106, as described below.

The engine control module 120 controls the operation of an internal combustion engine that may include an alternator for converting mechanical power from the engine to electrical power. The engine control module 120 may provide information regarding the operation of the engine to the battery control module 102.

The climate control module 122 controls the operation of a heating, ventilation, and air conditioning (HVAC) system of the vehicle. The vehicle may include a front and/or a rear HVAC system. The climate control module 122 may transmit information regarding the operation state of components that are part of the HVAC systems to the battery control module 102 via the data network 130. For example, the climate control module 122 may notify the battery control module 102 that the front and/or the rear HVAC systems are in an ON-state.

The audio-visual module 124 controls an entertainment system of the vehicle that includes speakers, liquid crystal display (LCD), radio, and/or microphone. The audio-visual module 124 may transmit information indicating the operation state (e.g., ON or OFF state) of these devices to the battery control module.

The passenger seat module 126 controls the operation of one or more seats disposed in the passenger cabin of the vehicle. The seats may be temperature controlled seats that include heating and/or cooling elements for controlling the temperature of the seat. The passenger seat module 126 transmits information to the battery control module 102 regarding the activation or deactivation of the temperature control features of the seat. For example, the passenger seat module 126 may transmit information indicating that the temperature control feature is OFF, in a HEAT mode, or in a COOL mode.

The battery control module 102 may also communicate with devices external of the vehicle by way of the communication module 128. For example, the battery control module 102 may transmit information regarding a condition of a defective battery to a service station via the communication module 128. The communication module 128 may transmit the information via wireless and/or wired communication. Wireless communication may include short range communication, such as Bluetooth, and/or long range communication that is supported by vehicle to infrastructure communication.

The battery monitor module 104 monitors operating conditions within the battery pack 106 and of each battery B. As an example, the battery monitor module 104 may monitor the charge-discharge rate of each battery B, the temperature of the battery pack 106, the state of charge (SOC) of each battery B, and/or other information for determining the condition and the life of the batteries B. The battery monitor module 104 may receive information from sensors disposed within the battery pack 106, such as a temperature sensor for monitoring temperature within the battery pack 106, a voltage sensor monitoring the voltage of each battery B, or a charge current sensor for monitoring the current supplied to the battery for charging the battery B. Based on the information from the sensors, and predetermined algorithms, the battery monitor module 104 may determine each of the operating conditions provided above.

Based on the operation conditions of the batteries B and the battery pack 106 determined by the battery monitor module 104, the battery control module 102 may determine if a battery needs to be charged, if a battery is defective, if a life of a battery has deteriorated, and/or other suitable condition for assessing the performance and quality of the batteries B in the battery pack 106. Information regarding the condition of the battery pack 106 and the batteries B within the battery pack 106 may be provided to the service station by way of the battery control module 102 and the communication module 128. As an example, if the performance of a given battery B from the battery pack 106 has deteriorated such that the battery is not able to maintain a charge for a predetermined amount of time or has a charge-discharge rate below a predetermined threshold, the battery monitor module 104 may send information indicative of such condition to the service station. The service station may then notify a driver of the vehicle of the low performing battery and recommend that the battery be replaced. For instance, the service stations may transmit the message to the communication module 128 and the communication module 128 may display the message using the LCD.

The switch device 108 controls each battery B within the battery pack 106 to provide power to one or more devices in the vehicle and/or to charge the battery B. Generally, a vehicle may include multiple devices that require the same electrical voltage (i.e., a standard-power device) and may also include one or more other devices that may require a larger amount of electrical voltage (i.e., a high-power device). The switch device 108 controls the batteries B to supply power to both standard-power devices and high-power devices. In addition, the switch device 108 may electrically couple the batteries B to a power source to charge the batteries B.

With continuing reference to FIG. 1, in the example embodiment, the switch device 108 is coupled to accessory devices 140, a motor-generator 142, a shore power connector 144, and an alternator 146. The switch device 108 has multiple ports 148 for coupling to various devices that receive and/or provide power to/from the batteries B. While the switch device 108 is illustrated as having four ports 148, it is readily understood that the switch device may include any number of ports (i.e., one or more ports) and is not limited to four.

The accessory devices 140 are standard-power devices and may include starters, fans, LCD, power seats, exterior light, interior lights, and/or other electrical devices that may require a standard voltage (e.g., 12V or 24V). In the example embodiment, the accessory devices 140 are coupled to the switch device 108 by way of a power distribution board (PDB) 150. Each low voltage device having the same power voltage requirement is coupled to the PDB 150, and the PDB 150 is electrically coupled to the switch device 108 at one of the ports 148 of the switch device 108. The PDB 150 distributes the requisite power voltage to the accessory devices 140. Alternatively, each accessory device 140 may be directly coupled to the switch device 108 by way of a designated port 148.

The motor-generator 142 may be considered a high-power device and may require 48V. Other high-power devices that may be coupled to the switch device 108 include AC compressors, a motor, and/or other electric device that may require more than the standard power. The motor-generator 142 converts electrical power from the batteries B to mechanical power to move the vehicle. The motor-generator 142 may also operate as a generator to charge the batteries B by converting, for example, mechanical or kinetic energy to electrical energy.

In addition to the motor-generator 142, the switch device 108 may charge the batteries B by way of the shore power connector 144 and/or the alternator 146. The shore power connector 144 connects to, for example, a 120V AC power outlet for charging one or more batteries B. The alternator 146 converts mechanical energy from an engine 152 to electrical power for charging the batteries B. A DC-DC converter may be coupled to the alternator 146 for converting the power from the alternator 146 to a requisite voltage level for charging the battery B. The shore power connector 144, the alternator 146, and/or the motor-generator 142 in the generator mode are examples of a power source for charging a battery B of the battery pack 106.

The switch device 108 controls the electrical connection of the battery pack 106 to the devices and/or the power source. For example, FIGS. 3A and 3B illustrate the switch device 108 controlling the electrical connection between a battery pack 300 with the alternator 146, the accessory device 140, and the motor-generator 142. The battery pack 300 includes six 12V batteries. Based on different operation scenarios, the switch device 108 is able to couple any single battery and/or combination of one or more batteries to any of the devices.

As an example, in FIG. 3A, the switch device 108 electrically couples: the battery B3 to the alternator 146 for charging the battery B3 (illustrated by line 302). In addition, batteries B1, B2, B4, and B5 are coupled in series to the motor-generator 142 for supplying supply 48V to the motor-generator 142 (illustrated by line 304). The battery B6 is coupled to the power distribution board 150 for supplying 12V to the accessory devices 140 (illustrated by line 306). In another example, illustrated in FIG. 3B, the switch device 108 electrically couples the battery B1 to the power distribution board 150, battery B6 to the alternator 146 for charging, and batteries B2 to B5 in series to the motor-generator 142. Accordingly, the battery system 100 of the present disclosure may meet the varying power demands of the different vehicle system by way of multiple batteries and the switch device 108. In other words, a DC-to-DC converter may not be needed for converting the power from the battery pack 106 to a higher/lower power level. That is, the switch device 108 may operate one battery to power a low volt device, may connect multiple batteries in series to operate a high volt device, and may charge the remaining batteries via a power source.

The switch device 108 of the battery system 100 may charge the batteries B based on the batteries B with the lowest SOC. Specifically, based on the information from the battery monitor module 104, the battery control module 102 may have the switch device 108 add and remove batteries as they charge. If one battery reaches 100% SOC, that battery can be removed from being charged and a battery with low SOC may be charged.

The switch device 108 includes a plurality of electrical switches that are operable to electrically couple the batteries B to a device (e.g., motor generator and/or the accessory devices) and/or to the power source (e.g., share power, alternator, and/or the accessory devices). The electrical switches are positioned to electrically couple two or more batteries in parallel or in series. In particular, the switch device 108 is connected to the positive and negative terminals of each of the batteries to control a given battery individually and/or to control multiple batteries in series/parallel.

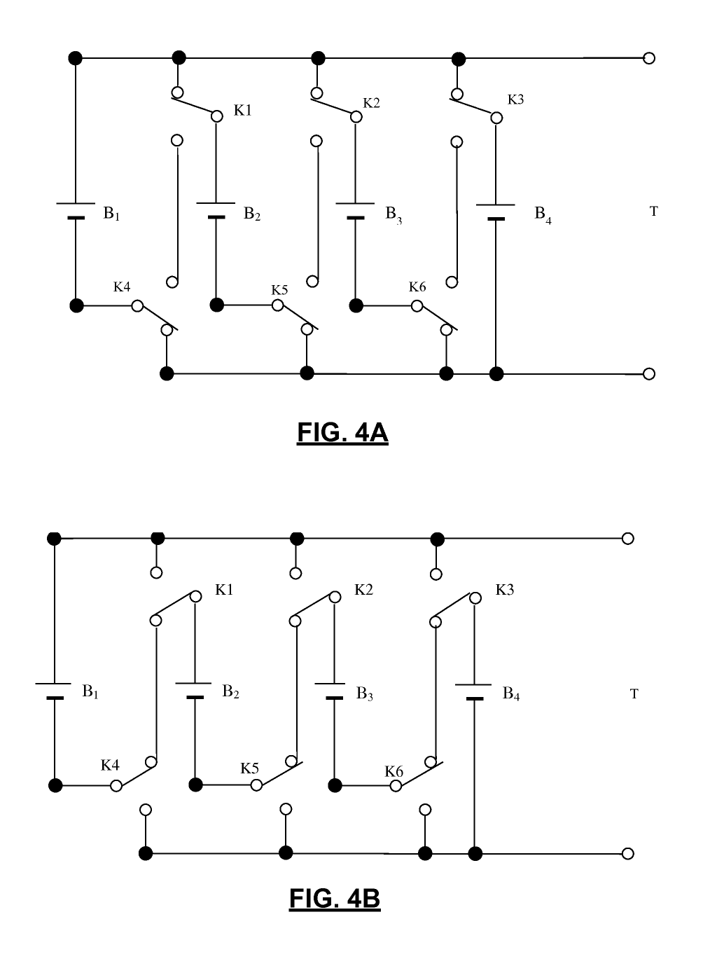

As an example, FIGS. 4A and 4B are simplified schematics illustrating four 12V batteries (B₁-B₄) and switches K1 to K6. The switches K1 to K6 may be relays or solid state switches that are electrically actuated by the switch device 108. In FIG. 4A, the batteries B1 to B4 are electrically coupled in parallel to output 12V across a designated terminal T. The terminal T may be electrically coupled to a port of the switch device, which in return is coupled to a power source to charge the batteries B1 to B4. Alternatively, the terminal T, via the port, may be electrically coupled to a PDB for supplying power to accessory devices requiring 12V. In FIG. 4B, the switches K1 to K6 are actuated to couple the batteries B1 to B6 in series to output 48V across the terminal T. The terminal T, via the port, may be coupled to a high power device, such as a motor or motor-generator 142.

FIG. 4C illustrates a configuration in which solid state switches, such as metal-oxide-semiconductor field-effect transistors (MOSFETs) are utilized for controlling the connection of the batteries. In FIG. 4C, nine MOSFETs K1-K9 perform as switches to electrically couple batteries B1 to B4 in parallel or in series. When electrical current is applied to the gate of a given MOSFET, current flows between the drain and the source. Thus, the MOSFET acts as a closed switch between the drain and the source. When electrical current is not applied to the gate, current is prevented from flowing between the drain and the source and, thus, the MOSFET operates as an open switch. Accordingly, when current is applied to the gates of MOSFETS K1-K6, the batteries B1 to B4 are electrically coupled in parallel to output 12V. When current is applied to the gates of MOSFETS K7 to K9, the batteries B1 to B4 are electrically coupled in series to output 48V. While the solid state switches are illustrated as MOSFETs, other suitable solid state switches may be used such as field-effect transistors.

An example implementation for operating the battery system 100 of the vehicle is presented. The battery control module 102 determines the power output requirement of the battery system 100 based on the operation of one or more devices, the condition of the batteries B provided by the battery monitor module 104, and predetermined battery operation allocation. The battery control module 102 transmits a command signal to the switch device 108 to have the switch device 108 electrically couple the batteries to designated ports.

With reference to FIG. 5, the battery control module may include a load assessment module 502 and a power designation module 504. The load assessment module 502 determines the operation of one or more designated vehicle systems as active or inactive. For example, based on the information from the other modules, the load assessment module 502 determines whether the engine is in operation, whether HVAC system is ON, and/or whether the shore power connector is plugged in.

Based on the operation of the vehicle systems, the power designation module 504 determines the connection of the batteries B. More particularly, the battery control module 102 includes a vehicle-battery repository 506 that stores predetermined vehicle-battery guidelines (VBG) 508. The vehicle-battery repository 506 is a storage device, such as a non-volatile memory. The vehicle-battery guidelines 508 associate the operation state of designated vehicle system with the operation of the battery system 100. As an example, the vehicle-battery control guidelines identify various operation scenarios of the vehicle system, such as the engine and the HVAC system both being OFF, the engine being OFF and the HVAC system being ON, and the engine being ON and the HVAC system being OFF. Each scenario is associated with a power supply allocation. For example, the power supply allocation may indicate that the battery system 100 is to supply power (e.g., 12V and/or 48V) in certain scenarios, and/or may determine whether another source is supplying power, such as an alternator or a shore power connector. The power supply allocation may also indicate whether the batteries not being used are to be charged. For example, when a DC motor is driving the vehicle, the switch device 108 can charge the batteries B that are not being used to power the DC motor. The vehicle-battery guidelines 508 may take various suitable forms such as predefined look up tables and/or control processes.

Using the vehicle-battery guidelines 508 and the operation condition of each battery B provided by the battery monitor module 104, the power designation module 504 determines the operation of each battery. Specifically, the power designation module 504 determines if the batteries B are to be coupled to a particular port 148 to supply power, which of the batteries B should be electrically coupled to each other and/or to the ports 148, and/or which of the batteries should be charged. The power designation module 504 then transmits a command signal to the switch device 108 for having the switch device 108 perform the electrical connection of the batteries B.

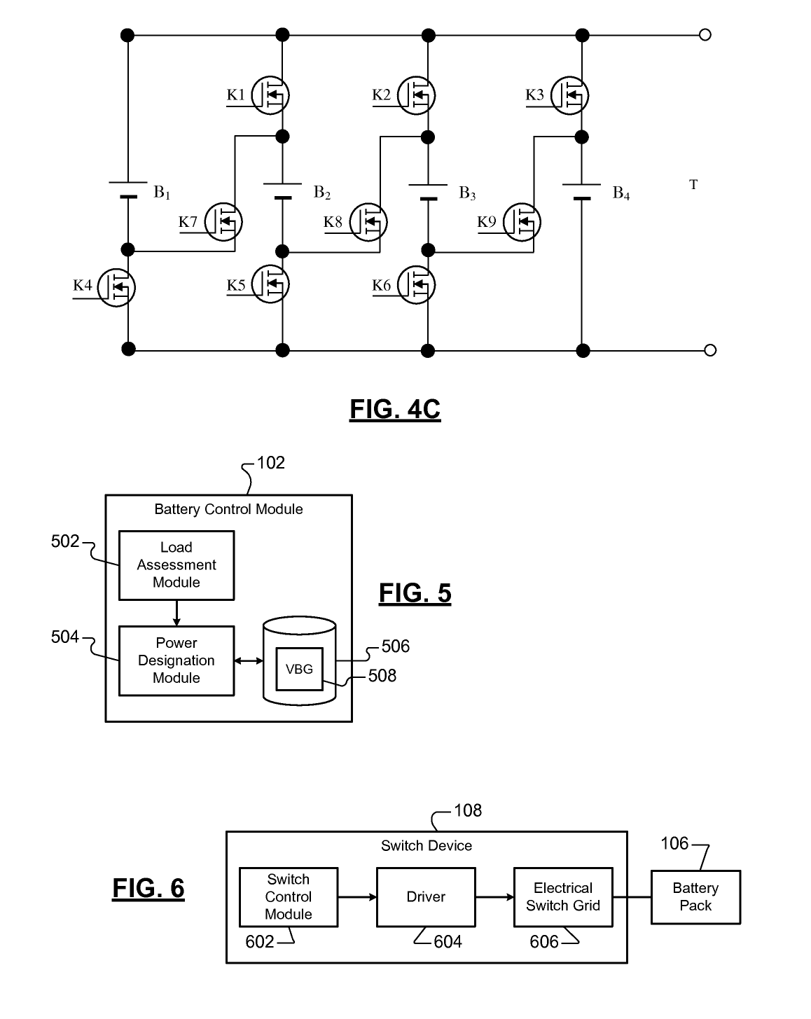

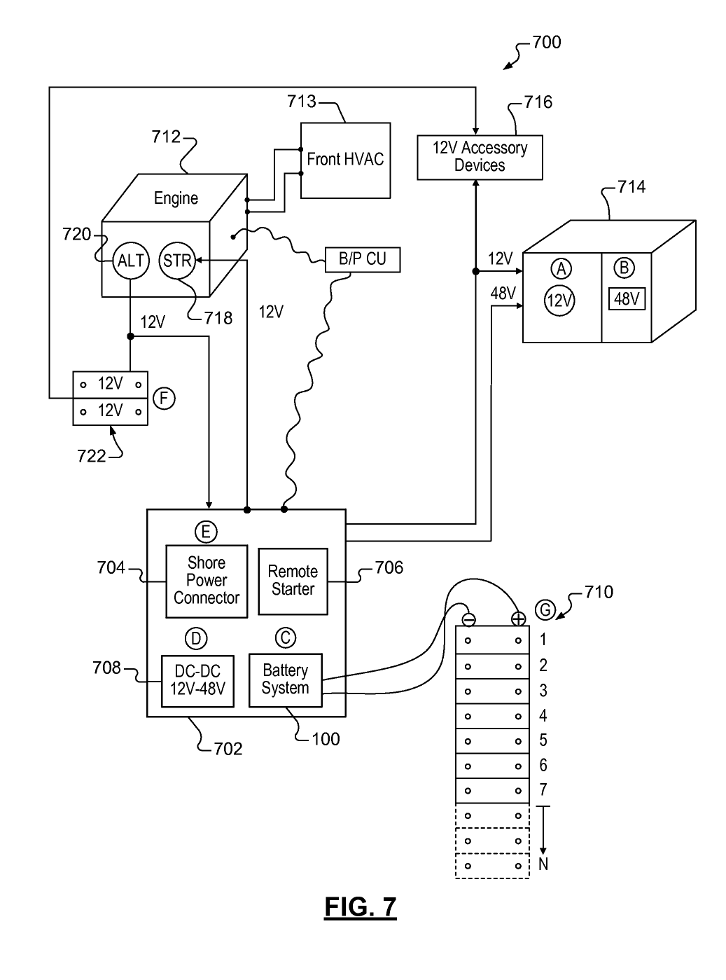

With reference to FIG. 6, the switch device 108 includes a switch control module 602 and a driver 604. The electrical switches used for connecting the batteries B in the battery pack 106 are collectively illustrated as an electrical switch grid 606. The driver 604 is electrically coupled to each electrical switch of the switch grid 606 to actuate a given switch. The switch control module 602 receives the command signal from the battery control module 102 and determines which switches are to be actuated for establishing the required electrical connection indicated in the command signal. The driver 604 transmits a current pulse to one or more desired switches in order to establish the electrical connection.

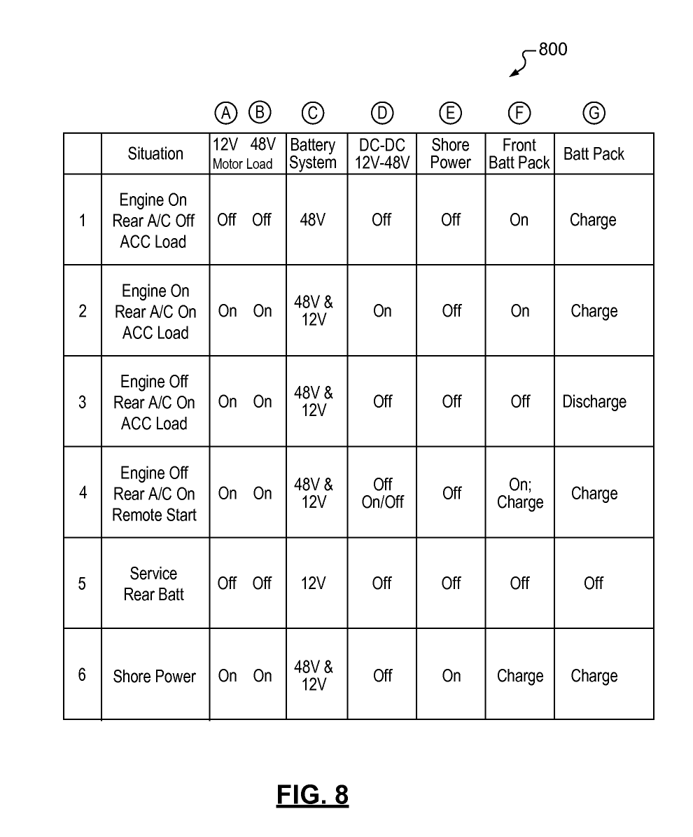

With reference to FIGS. 7 and 8, an example of a vehicle system 700 operating based on predetermined vehicle-battery guidelines is illustrated. The vehicle system 700 may be for a heavy duty truck that includes a living compartment in which a driver of the truck may reside when not driving the truck. The vehicle system 700 includes a power system 702 that includes a shore power connector 704, a remote starter 706, a DC-DC converter 708, and the battery system 100 having a battery pack 710. The vehicle system 700 further includes an engine 712, a front HVAC system 713, a rear HVAC system 714, and 12V accessory devices 716. The engine 712 includes a starter (STR) 718 that requires 12V and an alternator (ALT) 720 that may generate 12V when the engine 712 is operating. The alternator 720 may supply power to a front battery pack 722 that may supply power to the 12V accessory devices 716. The front battery pack 722 is separate from the battery pack 710 of the battery system 100. The rear HVAC system 714 includes components that require 12V or 48V. The accessory devices 716 may receive power from the battery pack 710 or from the front battery pack 722. The rear HVAC system 714 receives power from the battery pack 710 via the battery system 100.

The shore power connector 704 connects to, for example, a 120V AC power outlet and charges both battery packs 710 and 724. A rectifier (not shown) modifies the output of the 120V AC power from the outlet to 120V DC. The remote starter 706 receives a signal from a control unit that activates the engine 712 based on a signal from a key-fob. The remote starter 706 may activate the rear HVAC system 714 and the accessory devices 716. The DC-DC converter 708 may be used to convert 12V power from the alternator 720 to 48V, which can be used to charge the battery pack 710.

FIG. 8 illustrates a vehicle-battery operation table 800 that indicates the operation of the battery pack 710 in various situations. The letters A-G in the table 800 correspond with the letters in FIG. 7. For example, “A” represents the 12V devices of the rear HVAC system 714, “B” is the 48V devices of the rear HVAC system 714, “C” is the operation of the battery system 100, “D” is the operation of the DC-DC converter 708, “E” is the shore power connector 704, “F” is the battery pack 710, and “G” is the battery pack 710. Based on the operating conditions of at least the engine 712 and the rear HVAC system 714, the different subsystems are controlled. For example, when the engine 712 is ON and the rear HVAC system 714 is OFF, one or more batteries of the battery pack 710 may be charging, and the battery system 100 may be supplying 48V. When the engine 712 is ON and the rear HVAC system 714 is ON, the battery system 100 supplies power to 12V and 48V devices of the rear HVAC system 714. Some of the batteries of the battery pack 710 may be charged by the alternator 720 and DC-DC converter 708. When the engine 712 is OFF and the rear HVAC system 714 is ON, the battery pack 710 is discharging to supply power to the rear HVAC system 714.

By way of the switch device 108 and the battery control module 102, the battery system 100 may control each of the batteries B of the battery pack to supply power to standard devices and high power devices without the use of a DC-DC converter. Specifically, the battery system may not require a DC-DC converter to decrease or increase the voltage from the battery pack in order to power the different devices of the vehicle. Instead, the switch device 108 may electrically couple different batteries to different devices for supplying power to the devices disposed in the vehicle.

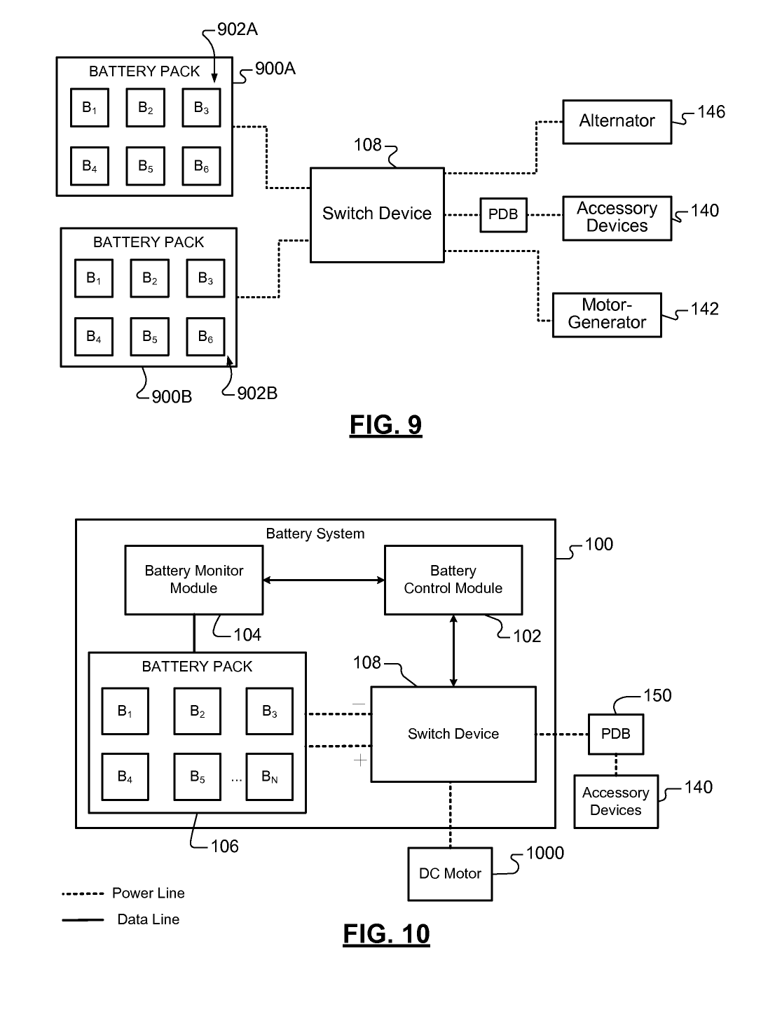

By having the switch device 108, the batteries of the battery pack may be split into different battery packs. For example, with reference to FIG. 9, the battery system 100 may include battery packs 900A and 900B. A first set of batteries 902A may be grouped in the battery pack 900A and a second set of batteries 902B may be grouped in a battery pack 900B. The battery packs 900A and 900B may be located in different locations in the vehicle. The switch device 108 is connected to each of the batteries 902A and 902B of the battery packs 900A and 900B to control the batteries 902A and 902B.

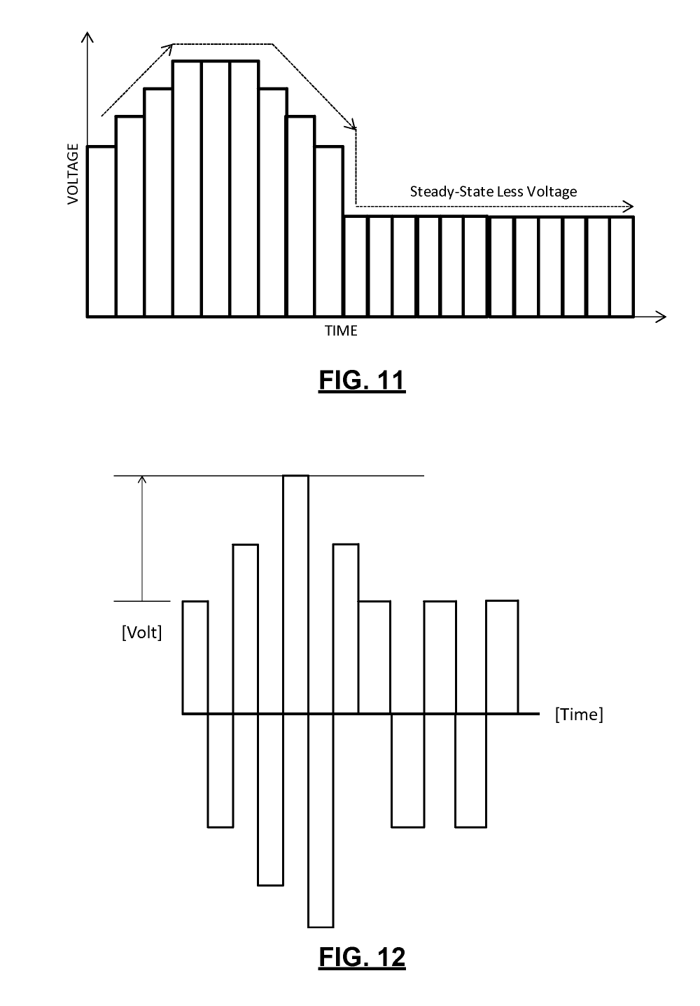

The battery system 100 of the present disclosure may also be used to operate a DC motor as an AC motor. Specifically, with reference to FIGS. 10-12, a vehicle system for a hybrid or electric vehicle may include a DC motor 1000 that moves the vehicle. The battery system 100 supplies power to the DC motor 1000 and may control the operation of the DC motor 1000 by increasing or decreasing the power. For example, as illustrated in FIG. 11, the switch device 108 may ramp-up/ramp-down voltage to the DC motor 1000 by connecting two or more batteries B in series and adding/removing batteries from a serial group of the batteries B.

By having the switch device 108, a vehicle may no longer require an AC inverter and an AC motor for driving the vehicle. Specifically, an inverter can be used to convert DC power from the batteries to power an AC motor. In the present disclosure, the switch device 108 varies the voltage applied to the DC motor 1000 to simulate an AC motor, thereby eliminating the need for an AC motor. The switch device 108 may also alternate between high and low voltage, as illustrated by FIG. 12, to drive the DC motor 1000 as an AC motor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCamI, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A battery system for a vehicle, the battery system comprising:
a battery pack including a plurality of batteries; and
a switch device including a plurality of switches, wherein the switches are electrically coupled to each of the batteries of the battery pack and are operable to control each of the batteries of the battery pack.

2. The battery system of claim 1 further comprising:
a battery monitor monitoring a power state of the batteries; and
a battery control module outputting a command signal to the switch device to control the batteries of the battery pack based on the power state of the batteries from the battery monitor.

3. The battery system of claim 2 further wherein the battery monitor monitors a state of charge and a charge rate of each of the batteries.

4. The battery system of claim 2 wherein the battery control module communicates with one or more system modules of the batteries that require power from the battery pack and determine the operation of the batteries of the battery pack based on information the system modules.

5. The battery system of claim 2 wherein:
the battery monitor determines a performance characteristic of the batteries of the battery pack; and
the battery control module outputs a battery status to an external device in response to the performance characteristic being below a threshold.

6. The battery system of claim 1 wherein the switches are metal-oxide-semiconductor field-effect transistors.

7. The battery system of claim 1 wherein the switch device is coupled to a positive terminal and a negative terminal of each of the batteries by way of the switches.

8. The battery system of claim 1 wherein the switch device controls each of the batteries independently of each other such that the batteries of the battery pack are operable individually and connectable in series or in parallel.

9. A vehicle system comprising:
a first subsystem operating a first device;
a second subsystem operating a second device;
a battery pack including a plurality of batteries; and
a switch device coupled to the first device and a second device and including a plurality of switches, wherein the switches are electrically coupled to each of the batteries of the battery pack and are operable to connect two or more batteries of the battery pack in series or in parallel, and
the switch device electrically couples the first device to a first battery set and the second device to a second battery set different from the first battery set, the first battery set and the second battery set are one or more batteries from among the plurality of batteries of the battery pack.

10. The vehicle system of claim 9 wherein:
the first device is a power distribution board that receives a first voltage from the battery pack via the switch device, and
the second device is a motor that receives a second voltage higher than the first voltage from the battery pack via the switch device.

11. The vehicle system of claim 10 wherein:
the switch device electrically couples one battery of the battery pack, as the first battery set, to the power distribution board to supply the first voltage, and
the switch device electrically couples two or more batteries of the battery pack in series, as the second battery set, and couples the second battery set to the motor to supply the second voltage.

12. The vehicle system of claim 9 wherein the switch device electrically couples two or more batteries of the battery pack in series, as the second battery set.

13. The vehicle system of claim 9 wherein:
the first device is a DC motor; and
the switch device electrically couples the DC motor to one or more batteries of the battery pack to supply a varying power voltage to the DC motor.

14. The vehicle system of claim 9 wherein the switch device electrical couples a third battery set different from the first battery set and the second battery set to a power source to charge the third battery set.

15. The vehicle system of claim 9 further comprising:
a battery monitor monitoring a power state of the batteries; and
a battery control module outputting a command signal to the switch device to control the batteries of the battery pack based on the power state of the batteries from the battery monitor and an operation state of the first subsystem and the second subsystem.

16. The vehicle system of claim 15 wherein the battery control module identifies the first battery set and the second battery set via the command signal and the switch device operates the switches to couple the first device to the first battery set and the second device to the second battery set.

17. The vehicle system of claim 9 wherein the switches are metal-oxide-semiconductor field-effect transistors.

18. The vehicle system of claim 9 wherein the switch device is coupled to a positive terminal and a negative terminal of each of the batteries by way of the switches.
